(19) United States
(12) Patent Application Publication
(10) Pub. No.: US 2026/0097392 A1
(43) Pub. Date: Apr. 9, 2026

(54) PREPARATION METHOD OF NICKEL CATALYST FOR HYDROGENATION REACTION

(71) Applicant: HANWHA SOLUTIONS CORPORATION, Seoul (KR)

(72) Inventors: Woo Jin PARK, Daejeon (KR); Eui Geun JUNG, Daejeon (KR); Bongsik JEON, Daejeon (KR); Byungjin LEE, Daejeon (KR)

(21) Appl. No.: 19/113,913

(22) PCT Filed: Sep. 21, 2023
(86) PCT No.: PCT/KR2023/014373

§ 371 Date: Mar. 21, 2025

(30) Foreign Application Priority Data
Sep. 22, 2022 (KR) 10-2022-0120131

(51) Int. Cl. B01J 23/755; B01J 21/08; B01J 35/61; B01J 35/63; B01J 35/64; B01J 37/02; B01J 37/03; B01J 37/08; B01J 37/18; C10G 45/48

(52) U.S. Cl. CPC B01J 23/755; B01J 21/08; B01J 35/615; B01J 35/633; B01J 35/647; B01J 37/0236; B01J 37/035; B01J 37/08; B01J 37/18; C10G 45/48; C10G 2300/1096

(57) ABSTRACT

The preparation method of a nickel catalyst for a hydrogenation reaction according to the invention subjects a nickel catalyst to a two-step passivation process after reduction, and thus, both safety and reaction activity of the nickel catalyst for a hydrogenation reaction of petroleum resin are excellent.

### CROSS-REFERENCE TO RELATED APPLICATIONS

This application claims the benefit of Korean Patent Application No. 10-2022-0120131 filed on Sep. 22, 2022 with the Korean Intellectual Property Office, the disclosures of which are herein incorporated by reference in their entirety.

### TECHNICAL FIELD

This invention relates to a preparation method of a nickel catalyst for a hydrogenation reaction, and more specifically, to a preparation method of a nickel catalyst wherein safety and reaction activity of the catalyst are improved through a two-step passivation process.

### BACKGROUND ART

In general, a hydrogenation reaction of an organic compound which is applied for reducing specific functional groups, or converting unsaturated compounds to saturated compounds, can be applied for a variety of compounds by reducing compounds having unsaturated functional groups such as ketone, aldehyde, imine, and the like to compounds such as alcohol, amine, and the like, or saturating unsaturated bonds of olefin compounds, and the like, and is one of commercially very important reactions.

Lowe olefin (i.e., ethylene, propylene, butylene and butadiene) and aromatic compounds (i.e., benzene, toluene and xylene) are basic intermediates widely used in petrochemistry and chemical industries. Thermal cracking, or steam pyrolysis is the main type of process for forming these materials typically in the presence of steam, and in the absence of oxygen. The feed stock may include petroleum gas such as naphtha, kerosene and gas oil, and distillates. Wherein, by thermal cracking of naphtha, and the like, C4 fractions including ethylene, propylene, butane and butadiene, C5 fractions including dicyclopentadiene (DCPD), cracked gasoline (including benzene, toluene, and xylene), cracked kerosene (C9 or more fractions), cracked heavy oil (ethylene residual oil, bottom oil) and hydrogen gas can be produced, and by polymerization from the fractions, and the like, petroleum resin can be prepared.

However, polymerized petroleum resin partly comprises double bonds of aromatic moieties (hereinafter, referred to as ‘aromatic double bonds’) and double bonds of aliphatic moieties (hereinafter, referred to as ‘olefinic double bonds’), and the higher the content of olefinic double bonds, the lower the quality of petroleum resin. Wherein, if a hydrogenation process of adding hydrogen to the olefinic double bonds is conducted, unsaturated double bonds may be saturated, and thus, the color may become bright, and the unique smell of petroleum resin may be reduced, thereby improving qualities.

During the hydrogenation reaction of petroleum resin, in order to control the content of aromatic double bonds, it is necessary to selectively hydrogenate olefinic bonds of polymerized resin. The selective hydrogenation reaction for olefinic double bonds may be generally conducted by contacting hydrogen and a reaction subject to be hydrogenated with a precious metal catalyst such as palladium (Pd), platinum (Pt), and the like, but the precious metal catalyst is very expensive and becomes the main cause of cost rise. Thus, commercially, a hydrogenation reaction of petroleum resin is conducted using nickel (Ni)-based catalysts.

For a nickel powder catalyst for a hydrogenation reaction of petroleum resin, due to the self-heating property, a method of making the transport, storage and use safe is necessary, and in order to achieve the same, a process of securing the safety of a nickel catalyst is being applied. For a nickel catalyst, in general, a passivation process using nitrogen mixed gas partly comprising air is used after a reduction process. Through the passivation process, a highly reactive nickel component reacts with air and is converted to nickel oxide (NiO), thereby securing use safety of a nickel catalyst.

However, since a part of nickel oxide formed is not regenerated to nickel during a hydrogenation reaction and thus reaction activity is decreased, the amount of a catalyst used increases. If the rate of nickel of a nickel catalyst being converted to nickel oxide is decreased, hydrogenation reaction performance may increase and the amount of a catalyst used may be reduced, but the risk of rapid heating may increase during transport, storage and use of a catalyst, thus raising an environmental safety issue in use.

### DISCLOSURE OF INVENTION

### Technical Problem

It is an object of the invention to provide a preparation method of a nickel catalyst for a hydrogenation reaction that has increased safety, and simultaneously, has excellent hydrogenation reaction activity.

### Technical Solution

In order to achieve the object, there is provided a method for preparing a nickel catalyst comprising: a step of preparing a catalyst precursor mixture comprising a nickel precursor (step 1); a step of precipitating the catalyst precursor mixture to obtain a catalyst precursor (step 2); a step of drying, calcining and reducing the catalyst precursor to prepare a catalyst (step 3); a first passivation step of passivating the catalyst using mixed gas comprising air and nitrogen (step 4); and a second passivation step of passivating the catalyst using mixed gas comprising air and nitrogen at a temperature different from the temperature of the first passivation step, after the first passivation step (step 5).

There is also provided a nickel catalyst comprising nickel on a solid carrier, and having H₂-TPR peak maximum at 120 to 200° C., wherein the half-width of the H₂-TPR peak is 90 or less, and a stabilization degree calculated by the following Calculation Formula 1 is 55 to 70%:

Stabilization degree(%)=(base area of TPR graph of catalyst÷weight of sample)/(base area of TPR graph of oxidized catalyst÷weight of sample))×100 [Calculation Formula 1]

As used herein, terms “a first”, “a second” and the like are used to explain various constructional elements, and they are used only to distinguish one constructional element from other constructional elements.

Further, the terms used herein are only to explain specific embodiments, and are not intended to limit the invention.

A singular expression includes a plural expression thereof, unless it is expressly stated or obvious from the context that such is not intended.

Throughout the specification, the terms “comprise”, “equipped” or “have”, etc. are intended to designate the existence of practiced characteristic, number, step, constructional element or combinations thereof, and they are not intended to preclude the possibility of existence or addition of one or more other characteristics, numbers, steps, constructional elements or combinations thereof.

Further, in case it is stated that each layer or element is formed “on” or “above” each layer or element, it means that each layer or element is formed right above each layer or element, or that other layers or elements may be additionally formed between the layers or on the object or substrate.

Although various modifications can be made to the invention and the invention may have various forms, specific examples will be illustrated and explained in detail below. However, it should be understood that they are not intended to limit the invention to specific disclosure, and that the invention includes all the modifications, equivalents or replacements thereof without departing from the spirit and technical scope of the invention.

As used herein, the term “nickel catalyst” means one structure wherein metal nickel particles and a support are physicochemically bonded, and “nickel” in the “nickel catalyst” includes both nickel metal and nickel oxide.

Hereinafter, the invention will be explained in detail.

The present disclosure relates to a passivation process of a catalyst after reduction, during the preparation process of a nickel catalyst, and relates to a preparation method of a nickel catalyst wherein the passivation step is conducted in two-steps at different temperatures.

A nickel catalyst is commonly passed through a passivation step for securing of safety, and the degree of passivation has an influence on the safety or reaction activity of a catalyst when used in the subsequent reaction. In the present disclosure, a nickel catalyst is prepared through a two-step passivation process, and thus, it is characterized by having excellent safety and reaction activity.

Hereinafter, the invention will be explained in detail according to steps.

### (Step 1)

The step 1 of the invention is a step of preparing a catalyst precursor mixture comprising a nickel precursor.

The nickel catalyst used in the present disclosure may be prepared using a variety of nickel precursors. As examples of the nickel precursors, nitrate, acetate, sulfate, chloride of nickel may be used, and preferably, nickel sulfate may be used, but the nickel precursors are not limited thereto.

According to one embodiment of the invention, the catalyst precursor mixture of the step 1 may further comprise one or more of a carrier, and a promoter precursor. The kind of the carrier is not specifically limited, and for example, one or more selected from the group consisting of SiO₂, Al₂O₃, MgO, MgCl₂, CaCl₂), ZrO₂, TiO₂, B₂O₃, CaO, ZnO, BaO, ThO₂, SiO₂—Al₂O₃, SiO₂—MgO, SiO₂—TiO₂, SiO₂—V₂O₅, SiO₂—CrO₂O₃, SiO₂—TiO₂—MgO, and zeolite may be used. Among them, a carrier containing silica (SiO₂) may be representatively used.

Further, the kind of the promoter precursor is not specifically limited, and for example, it may be oxide, nitrate, acetate, sulfate, chloride containing copper, potassium, sulfur, and the like, or a combination thereof, and preferably, copper sulfate may be used, but the promoter precursor is not limited thereto.

Meanwhile, the catalyst precursor mixture may be prepared by mixing in a solvent, and the kind of the solvent is not specifically limited, but water, methanol or ethanol, and the like may be used, and preferably, water may be used. Further, a mixing method of the catalyst precursor mixture is not specifically limited. For example, it may be prepared by dissolving nickel and promoter precursors in a solvent, and then, adding a carrier, or it may be prepared by adding a carrier to a solvent to prepare a suspending solution, and then, adding nickel and cocatalyst precursors.

### (Step 2)

The step 2 of the present disclosure is a step of preparing the catalyst precursor mixture prepared in the step 1 into a catalyst precursor using a precipitant.

In the step 2, a method of preparing the catalyst precursor mixture into a catalyst precursor is not specifically limited, and it may be commonly prepared by a precipitation method, and specifically, a co-precipitation, impregnation, or deposition-precipitation method, and the like may be used.

For example, after introducing a nickel precursor, a promoter precursor, and a carrier in a solvent to prepare a catalyst precursor mixture in the step 1, a precipitant may be added to the catalyst precursor mixture, thereby depositing nickel and promoter components in a solid carrier suspended in a solvent.

Further, the precipitant that can be used may be selected considering the nickel support amount of a catalyst prepared, the size of nickel crystal, and dispersibility of nickel, and the like. Preferably, as the precipitant of the step 2, one or more of sodium carbonate and sodium hydrogen carbonate may be used.

### (Step 3)

The step 3 of the present disclosure is a step of drying, calcining and reducing the catalyst precursor prepared in the step 2 to prepare a catalyst.

First, drying is a step of drying the solvent of the catalyst precursor to prepare a dried substance. Wherein, the drying temperature and time may be selected to be sufficient for removing the solvent, and although not specifically limited, drying may be conducted at a temperature of 80 to 200° C., for 5 to 30 hours. Further, before drying, a step of washing and filtering the catalyst precursor prepared through the step 2 may be further conducted.

After preparing the dried substance, calcination of the catalyst precursor is progressed. The calcination may be conducted under air atmosphere, and may be conducted at 180 to 500° C., 200 to 450° C., or 250 to 400° C. If the calcination temperature is less than the above range, dispersibility of active species nickel may be deteriorated, and if it exceeds the above range, sintering of nickel may occur, thus deteriorating reaction activity.

Since the calcination is generally progressed in the air, nickel included in the catalyst precursor mostly exists in the form of nickel oxide, and nickel oxide generally has low hydrogeneration reaction activity compared to nickel, it is in general that nickel oxide is reduced again before use. Thus, after the calcination of the catalyst precursor, reduction is conducted before using as a catalyst.

The reduction of the step 3 may be conducted at a temperature of 300 to 600° C. under hydrogen atmosphere. If the reduction temperature is less than the above range, reduction of the catalyst may not be appropriately achieved, and if the reduction temperature exceeds the above range, sintering of active metal may occur. More preferably, the reduction may be conducted at a temperature of 350 to 550° C., or 400 to 500° C.

### (Step 4)

The nickel catalyst prepared through the reduction of the catalyst precursor is subjected to a passivation step to make transport, storage and use safe, as explained above. The step 4 corresponds to a first passivation step of the two-step passivation process of the present disclosure.

The existing passivation step has been progressed by converting a part of nickel of a catalyst into nickel oxide, or depositing the prepared catalyst in an organic solvent capable of blocking the air. However, the existing method was difficult to fulfill both safety and reaction activity of a catalyst. The researchers of the present disclosure confirmed through continuous experiments that by conducting the passivation process in two steps at different temperatures, a catalyst having excellent reaction activity as well as safety of transport, storage and use can be prepared.

The first passivation step is a step of passivating the catalyst using mixed gas comprising air and nitrogen. Wherein, the air may include nitrogen, oxygen, carbon monoxide, carbon dioxide, argon, and the like. More specifically, in the air, about 78 vol % of nitrogen, about 21 vol % of oxygen, about 0.93 vol % of argon may be included, and additionally, carbon dioxide, carbon monoxide, and water vapor, and the like may be further included.

Preferably, based on the total volume of the air and nitrogen mixed gas of the step 4, 0.1 to 2 vol % of air may be included. If the ratio of the air in the mixed gas is less than the above range, conversion of nickel into nickel oxide may not be appropriately achieved, and if it exceeds the above range, catalyst activity may be deteriorated. More preferably, based on the total volume of the mixed gas, the air may be included in the content of 0.15 vol % or more, 0.2 vol % or more, or 0.3 vol % or more, and 1.7 vol % or less, 1.5 vol % or less, or 1.2 vol % or less.

Preferably, the first passivation step of the step 4 may be conducted at a temperature of 15 to 50° C. It is preferable that the first passivation step of the present disclosure is conducted at a temperature lower than that of the second passivation step. In the first passivation step, by progressing passivation relatively slowly through contact with air under mild condition, the catalyst can be stably passivated. More preferably, the first passivation step may be conducted at a temperature of 17° C. or more, 20° C. or more, or 22° C. or more, and 45° C. or less, 40° C. or less, 35° C. or less, or 30° C. or less.

Further, preferably, the first passivation step of the step 4 may be conducted for 5 to 24 hours. The running time of the first passivation step may have an influence on the stability of the passivated catalyst, and if the running time of the first passivation step is less than 5 hours or greater than 24 hours, safety and reaction activity of the catalyst may be deteriorated.

### (Step 5)

The step 5 of the present disclosure is a step of conducting a second passivation step using mixed gas including air and nitrogen, after the first passivation step of the catalyst.

Meanwhile, the mixed gas used in this step is mixed gas including air and nitrogen, and is identical to the composition of the mixed gas used in the first passivation step of the step 4. As to the composition of the air and the volume of the air in the mixed gas, explanations of the step 4 may be referred to.

Preferably, the second passivation step of the step 5 may be conducted at a temperature higher than that of the first passivation step. As explained above, in the second passivation step, by conducting a passivation step once more after conducting the first passivation step, the surface of non-passivated nickel, or passivated nickel oxide may be further passivated. As such, in case the prepared nickel catalyst is passivated in two steps, the safety of the catalyst prepared may become suitable for commercial use, and the catalyst prepared may also have excellent activity in a hydrogenation reaction. More specifically, the second passivation step of the step 5 may be conducted at a temperature of 50° C. or more, or 60° C. or more, and 150° C. or less, 140° C. or less, 130° C. or less, or 120° C. or less.

Further, according to the invention, there is provided a nickel catalyst comprising nickel on a solid carrier, and having H₂-TPR peak maximum at 120 to 200° C., wherein the half-width of the H₂-TPR peak is 90 or less, and stabilization degree calculated by the following Calculation Formula 1 is 55 to 70%:

Stabilization degree(%)=(base area of TPR graph of catalyst÷weight of sample)/(base area of TPR graph of oxidized catalyst÷weight of sample))×100 [Calculation Formula 1]

As to the nickel included in the nickel catalyst and the carrier, the above explanations are referred to.

The H₂-TPR (Temperature Programmed Reduction) is a measurement method for evaluating the reduction capability of a catalyst using hydrogen gas. TPR increases temperature to a target temperature at the established temperature rise speed, while flowing gas to a catalyst sample, and evaluates the reduction degree of the catalyst. Wherein, if the catalyst sample is reduced by reducing gas, a peak is generated, and the peak maximum means a point where the consumption amount of hydrogen at a specific temperature is the highest. Further, the smaller the half-width of the peak, the higher the uniformity of the active components of the nickel catalyst prepared. Preferably, the nickel catalyst of the invention has the H₂-TPR peak maximum at 120 to 200° C., 125 to 195° C., 130 to 190° C., or 135 to 185° C. If the H₂-TPR peak value is less than 120° C., use safety of the catalyst may be remarkably lowered, and thus, it may easily get hot, thus increasing danger of an accident. If the H₂-TPR peak value is greater than 200° C., activity may be lowered during the reaction, and thus, the amount of the catalyst used may increase.

Further, the half-width of H₂-TPR peak is 90 or less. If the half-width of H₂-TPR peak is wide, performance uniformity of the catalyst may be deteriorated, and as it is smaller, it is more favorable for securing of uniformity of catalyst activity and lifetime performance, the reaction process may be safely controlled, and catalyst performance is more excellent, and thus, the lower limit is not specifically limited, but for example, it may be 85 or less, 80 or less, or 75 or less, and 30 or more, 35 or more, or 40 or more.

Further, the nickel catalyst according to the invention has a stabilization degree calculated by the following Calculation Formula 1, of 55 to 70%. The base area of the H₂-TPR graph means hydrogen consumption amount in the catalyst reduction process. Meanwhile, in the following Calculation Formula 1, “TPR graph of catalyst” means the TPR graph measured without progressing pre-treatment, and “TPR graph of oxidized catalyst” means the TPR graph of a catalyst subjected to oxidation pre-treatment before TPR measurement.

$$[ Calculation Formula 1 ]$$

$$Stabilization degree ( \% ) = ( base area of TPR graph of catalyst \div weight of sample ) / ( base area of TPR graph of oxidized catalyst \div weight of sample ) ) ⨯ 100$$

The stabilization degree is calculated by the analysis of each TPR graph, and represents change in hydrogen consumption amount according to temperature rise, namely, a degree of change in the reducing power of the catalyst. If the stabilization degree calculated is high, use safety of the catalyst may increase, but the activity and lifetime performance of the catalyst may be deteriorated. If the stabilization degree is low, in case the catalyst is exposed to the air, it may be easily self-heated, thus increasing dangerousness, but the activity and lifetime performance of the catalyst may increase. Thus, it is preferable that the stabilization degree has a specific range simultaneously fulfilling use safety, and activity and lifetime performance of a catalyst. In the measurement of the H₂-TPR graph, the pre-treatment method of a sample, TPR measurement conditions, and the calculation method of the base area of a graph will be embodied in Examples described below.

### Effects

As explained above, according to the preparation method of a nickel catalyst for a hydrogenation reaction of the present disclosure, a two-step passivation process is conducted, and thus, safety and reaction activity of the catalyst are excellent.

### BRIEF DESCRIPTION OF DRAWINGS

FIG. 1 is the image of the H₂-TPR graph of the nickel catalyst prepared in Example 1.

### BEST MODE FOR CARRYING OUT THE INVENTION

Hereinafter, preferable examples will be presented to assist in understanding of the invention. However, following examples are presented only as the illustrations of the invention, and the invention is not limited thereby.

### EXAMPLE

### Example 1

1.5 kg of amorphous silica powder, 20 kg of nickel sulfate, 222 g of copper sulfate and 60 L of distilled water were put in a precipitation container, and the temperature was raised to 75° C. under stirring. 75 L of a precipitant solution including 12.5 kg of sodium carbonate was entirely injected into the reactor of the raw material solution for 1 hour using a diaphragm pump. After precipitation was completed, the solution was filtered with a filter press and washed with 600 L of distilled water. After washing, it was dried at 120° C. for 24 hours using a drying oven. It was divided into small pieces, and then, calcined at a temperature of 300° C. under air atmosphere. It was divided into small pieces again, and then, reduced at a temperature of 400° C. under hydrogen atmosphere.

After reduction, it was pre-treated at 25° C. for 12 hours using nitrogen mixed gas containing 1 vol % of air, and the temperature was raised to 60° C., and then, additionally heat-treated for 1 hour. After the concentration of air was gradually increased, the catalyst was safely recovered.

The active material contents of the recovered catalyst were 78.2 parts by weight of NiO, and 0.8 parts by weight of CuO, based on the weight of the catalyst, and the average size of nickel crystals was measured to be 4.1 nm. Further, it had BET specific area of 245 m²/g, total pore volume of 0.33 m³/g, and average pore size of 5.5 nm.

### Example 2

A catalyst was prepared by the same method as Example 1, except that after reduction, it was treated at 25° C. for 12 hours using nitrogen mixed gas containing 1 vol % of air, and the temperature was raised to 80° C., and then, the catalyst was additionally heat treated for 1 hour.

### Example 3

A catalyst was prepared by the same method as Example 1, except that after reduction, it was treated at 25° C. for 12 hours using nitrogen mixed gas containing 1 vol % of air, and the temperature was raised to 100° C., and then, the catalyst was additionally heat treated for 1 hour.

### Example 4

A catalyst was prepared by the same method as Example 1, except that after reduction, it was treated at 25° C. for 12 hours using nitrogen mixed gas containing 1 vol % of air, and the temperature was raised to 120° C., and then, the catalyst was additionally heat treated for 1 hour.

### Comparative Example 1

A catalyst was prepared by the same method as Example 1, except that after reduction, it was heat treated at 25° C. for 12 hours using nitrogen mixed gas containing 1 vol % of air, and the concentration of air was gradually increased to safely recover the catalyst.

### Comparative Example 2

A catalyst was prepared by the same method as Comparative Example 1, except that after reduction, it was heat treated at 60° C. for 12 hours using nitrogen mixed gas containing 1 vol % of air,

### Comparative Example 3

A catalyst was prepared by the same method as Comparative Example 1, except that after reduction, it was heat treated at 80° C. for 12 hours using nitrogen mixed gas containing 1 vol % of air,

### Comparative Example 4

A catalyst was prepared by the same method as Comparative Example 1, except that after reduction, it was heat treated at 100° C. for 12 hours using nitrogen mixed gas containing 1 vol % of air,

### Comparative Example 5

A catalyst was prepared by the same method as Comparative Example 1, except that after reduction, it was heat treated at 120° C. for 12 hours using nitrogen mixed gas containing 1 vol % of air,

### Experimental Example

For the above prepared catalysts, characterization was analyzed and reaction activity was measured as follows.

### (1) H₂-TPR Analysis

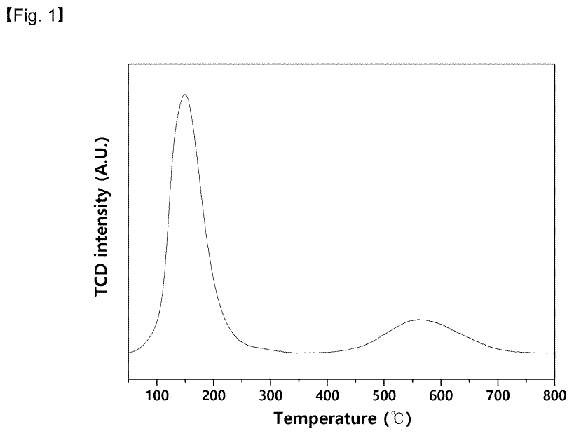

The properties of the catalysts were analyzed using Belcat II equipment of MicrotracBEL corporation. Representatively, the H₂-TPR graph of the catalyst prepared in Example 1 was shown in FIG. 1. In the processes of reduction of the oxidized catalyst and reduction of the catalyst, hydrogen consumption amount was measured, and based on the ratio, the stabilization degree of the catalyst was calculated according to the following Calculation Formula 1.

Wherein, the weight of the sample is 50 mg, the analysis conditions of oxidized catalyst are as described in the following Table 1, and the analysis conditions of the catalyst are as described in the following Table 2. The TPR graph was obtained by the Nonlinear curve fit (Gauss) method using Origin 9.1 program, and the results are shown in the following Table 3.

$$[ Calculation Formula 1 ]$$

$$Stabilization degree ( \% ) = ( base area of TPR graph of catalyst \div weight of sample ) / ( base area of TPR graph of oxidized catalyst \div weight of sample ) ) ⨯ 100$$

TABLE 1

| | | | | | Start | Final | Temperature |
|---|---|---|---|---|---|---|---|
| | | | Flow rate | Time | temperature | temperature | rise rate |
| order | step | gas | (mL/min) | (min) | (° C.) | (° C.) | (° C./min) |
| 1 | Temperature | Ar | 30 | 30 | 0 | 300 | 10 |
| | rise | | | | | | |
| 2 | Reduction | H₂/Ar¹ | 30 | 45 | 300 | 300 | — |
| 3 | Temperature | Ar | 30 | 10 | 300 | 400 | 10 |
| | rise | | | | | | |
| 4 | Oxidation | O₂ | 30 | 120 | 400 | 400 | — |
| 5 | Cooling | Ar | 30 | | 300 | 60 | — |
| 6 | TCD | Ar | 30 | 35 | 60 | 60 | — |
| | stabilization | | | | | | |
| 7 | H₂-TPR | H₂/Ar¹ | 30 | 150 | 60 | 810 | 5 |
| | analysis | | | | | | |
| 8 | Purge | Ar | 30 | 10 | 810 | 810 | — |

¹5% H₂/Ar balanced gas (H₂ 1.5 mL/min, Ar 28.5 mL/min)

TABLE 2

| | | | | | Start | Final | Temperature |
|---|---|---|---|---|---|---|---|
| | | | Flow rate | Time | temperature | temperature | rise rate |
| order | Step | gas | (mL/min) | (min) | (° C.) | (° C.) | (° C./min) |
| 1 | Temperature | Ar | 30 | 6 | 0 | 30 | 5 |
| | rise | | | | | | |
| 2 | Purge | Ar | 30 | 10 | 30 | 30 | — |
| 3 | TCD | Ar | 30 | 35 | 30 | 30 | — |
| | stabilization | | | | | | |
| 4 | H₂-TPR | H₂/Ar¹ | 30 | 156 | 30 | 810 | 5 |
| | analysis | | | | | | |
| 5 | Purge | Ar | 30 | 10 | 810 | 810 | — |

¹5% H₂/Ar balanced gas (H₂ 1.5 mL/min, Ar 28.5 mL/min)

### (2) Evaluation of Catalyst Activity

A 300 ml autoclave including a hollow shaft agitator, and having an agitation speed of 1,600 rpm was used. Non-hydrogenated petroleum resin (Hanwha solution DCPD polymerized resin: styrene monomers 20 wt % and DCPD 80 wt %) was dissolved in cyclohexane at the concentration of 30 wt % to prepare 75 g of a mixed solution. And then, at 200° C., 50 bar, the catalyst was added in the content of 2%, based on the mass of the petroleum resin, to hydrogenate, and 1 hour after the reaction began, NMR of the petroleum resin was analyzed and the rate of hydrogenation compared to the non-hydrogenated petroleum resin was calculated and shown in Table 3.

TABLE 3

| | | | H₂-TPR analysis result | | | |
|---|---|---|---|---|---|---|
| | Passivation | | | Peak of | Half-width | |
| | temperature | | Stabilization | passivation | of | Catalyst |
| | (° C.) | | degree | layer | passivation | activity |
| | primary | secondary | (%) | (° C.) | layer | (%) |
| Example 1 | 25 | 60 | 56 | 129 | 47 | 95 |
| Example 2 | 25 | 80 | 60 | 161 | 53 | 93 |
| Example 3 | 25 | 100 | 65 | 175 | 61 | 92 |
| Example 4 | 25 | 120 | 70 | 196 | 86 | 89 |
| Comparative | 25 | — | 42 | 131 | 74 | — |
| Example 1 | | | | | | |
| Comparative | 60 | — | 45 | 154 | 83 | — |
| Example 2 | | | | | | |
| Comparative | 80 | — | 52 | 205 | 103 | — |
| Example 3 | | | | | | |
| Comparative | 100 | — | 72 | 220 | 116 | 65 |
| Example 4 | | | | | | |
| Comparative | 120 | — | 77 | 246 | 132 | 59 |
| Example 5 | | | | | | |

As confirmed in the Table 3, the nickel catalysts prepared according to the preparation method of Examples of the present disclosure have excellent stabilization degree and reaction activity. Meanwhile, the catalysts of Comparative Examples 1 to 4 have low stabilization degree compared to the catalysts of Examples, and thus, when exposed to air during experiment, rapid self-heating was involved, and the active reaction test could not be conducted. It can be confirmed that the catalysts of Comparative Examples 4 and 5 have improved stabilization degrees, but the activities are significantly lowered. The catalyst of the present disclosure can realize safety and excellent reaction activity of the catalyst through the two-step passivation process.

1. A method for preparing a nickel catalyst comprising:
a step of preparing a catalyst precursor mixture comprising a nickel precursor (step 1);
a step of precipitating the catalyst precursor mixture to obtain a catalyst precursor (step 2);
a step of drying, calcining and reducing the catalyst precursor to prepare a catalyst (step 3);
a first passivation step of passivating the catalyst using mixed gas comprising air and nitrogen (step 4); and
a second passivation step of passivating the catalyst using mixed gas comprising air and nitrogen at a temperature different from the temperature of the first passivation step, after the first passivation step (step 5).

2. The method for preparing a nickel catalyst according to claim 1, wherein the catalyst precursor mixture of the step 1 further comprises one or more of a carrier, and a promoter precursor.

3. The method for preparing a nickel catalyst according to claim 1, wherein as a precipitant of the step 2, one or more of sodium carbonate and sodium hydrogen carbonate are used.

4. The method for preparing a nickel catalyst according to claim 1, wherein the drying of the step 3 is conducted at a temperature of 80 to 200° C.

5. The method for preparing a nickel catalyst according to claim 1, wherein the calcination of the step 3 is conducted at a temperature of 180 to 500° C. under air atmosphere.

6. The method for preparing a nickel catalyst according to claim 1, wherein the reduction of the step 3 is conducted at a temperature of 300 to 600° C. under hydrogen atmosphere.

7. The method for preparing a nickel catalyst according to claim 1, wherein based on the total volume of the air and nitrogen mixed gas of the step 4, 0.1 to 2 vol % of the air is included.

8. The method for preparing a nickel catalyst according to claim 1, wherein the first passivation step of the step 4 is conducted at a temperature of 15 to 50° C.

9. The method for preparing a nickel catalyst according to claim 1, wherein the first passivation step of the step 4 is conducted for 5 to 24 hours.

10. The method for preparing a nickel catalyst according to claim 1, wherein the second passivation step of the step 5 is conducted at a temperature higher than the temperature of the first passivation step.

11. The method for preparing a nickel catalyst according to claim 1, wherein the second passivation step of the step 5 is conducted at a temperature of 50 to 150° C.

12. A nickel catalyst comprising nickel on a solid carrier, and
having H₂-TPR peak maximum at 120 to 200° C.,
wherein the half-width of the H₂-TPR peak is 90 or less, and
a stabilization degree calculated by the following Calculation Formula 1 is 55 to 70%:
$$[ Calculation Formula 1 ]$$
$$Stabilization degree ( \% ) = ( base area of TPR graph of catalyst \div weight of sample ) / ( base area of TPR graph of oxidized catalyst \div weight of sample ) ) ⨯ 100$$
